(19) United States
(12) Patent Application Publication
(10) Pub. No.: US 2009/0128742 A1
(43) Pub. Date: May 21, 2009

(54) METHOD OF PRODUCING FLUORESCENCE SUBSTANCE SUSPENSION, FLUORESCENT LAMP, BACKLIGHT UNIT, DIRECTLY-BELOW TYPE BACKLIGHT UNIT AND LIQUID CRYSTAL DISPLAY UNIT

(76) Inventors: Nozomu Hashimoto, Osaka (JP); Kazuhiro Matsuo, Osaka (JP); Katsumi Itagaki, Kyoto (JP); Mitsuharu Kawasaki, Kyoto (JP); Hiroyuki Arata, Hyogo (JP); Yuko Habuta, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 11/915,015

(22) PCT Filed: Jul. 12, 2006
(86) PCT No.: PCT/JP2006/313833

§ 371 Date: Nov. 20, 2007

(30) Foreign Application Priority Data
Jul. 29, 2005 (JP) 2005-221206
Dec. 15, 2005 (JP) 2005-362200

(51) Int. Cl. G02F 1/13357; H01J 63/04; H01J 9/22; C09K 11/00; G09F 13/08

(52) U.S. Cl. 349/70; 313/485; 445/58; 362/97.1; 313/487; 252/301.4 R

(57) ABSTRACT

The present invention relates to a manufacturing method for a phosphor suspension to be applied to an inner surface of a glass bulb of a fluorescent lamp, and a fluorescent lamp manufactured with use of the phosphor suspension.

The method comprising the steps of kneading a mixture (38) of a small amount of solvent (32) including a thickening agent and a phosphor powder (30), and agitating the mixture after adding a solvent (40) including a thickening agent and a binding agent, and a metal compound as a coating agent (42) to the mixture.

The fluorescent lamp pertaining to the present invention includes a phosphor layer formed by applying the phosphor suspension manufactured by the above-described method to the inner surface of the glass bulb, drying the suspension, and baking the suspension.

Since the method pertaining to the present invention comprises the step of kneading, the phosphor particles included in the formed phosphor layer are densely arranged. As a result, the contact area between the phosphor particles and the inner surface of the glass bulb becomes large, and the phosphor layer hardly peels off. Also, since the phosphor particles are coated with the metal compound, the phosphor particles are prevented from reacting with Na included in the glass bulb and becoming degraded.

### TECHNICAL FIELD

The present invention relates to a phosphor suspension manufacturing method, a fluorescent lamp, a backlight unit, a direct-type backlight unit, and a liquid crystal display apparatus.

### BACKGROUND ART

It is a commonly adopted method that a phosphor layer is manufactured by applying a phosphor suspension, consisted of a solvent in which a phosphor powder, a thickening agent, a binding agent and so on are dispersed, to the internal surface of a glass tube, drying the suspension, and then baking the suspension.

In a suggested method for manufacturing a phosphor suspension (see Patent Document 1), a phosphor powder, a thickening agent and a binding agent are not mixed at the same time. Instead, firstly a little amount of the solvent including the thickening agent is added to the phosphor powder and kneaded, and then a solvent including a thickening agent and a binding agent is further added to the phosphor powder, and agitated.

In the above-mentioned kneading process, the agglomeration of the phosphor powder is decomposed into primary particles because the phosphor powder is kneaded with a little amount of the solvent. Accordingly, it is possible to arrange the phosphor particles in a phosphor layer without gaps. This improves the adherability of the film.

### Patent Document 1: Japanese Laid-open Patent Application Publication No. 2005-294049

### DISCLOSURE OF THE INVENTION

### Problems to be Solved by the Invention

However, the inventors of the present invention found that although the above-mentioned method improves the adherability of the film of the fluorescent lamp, the phosphor particles included in the phosphor layer is vulnerable to degradation.

This is because the contact area between the phosphor particles and the inner surface of the glass tube is large due to the dense arrangement of the phosphor particles, and the phosphor particles readily react with the glass tube material (Na).

In this regard, if decreasing the contact area by sparsely arranging the phosphor particles, it is possible to prevent the degradation of the phosphor particles. However, this decreases the adherability of the phosphor layer, which brings up a dilemma.

In particular, the cold-cathode fluorescent lamps having a glass tube with a small diameter are used as a light source for a backlight unit of a liquid crystal monitor. In accordance with a demand for miniaturization of monitors, the diameter and the wall thickness of the glass tube thereof is decreasing.

Since a glass tube with a thin wall (e.g. not greater than 0.5 mm) readily warps, it is necessary to improve the adherability.

The present invention is made in terms of the problem mentioned above. The object of the present invention is to provide a manufacturing method for a phosphor suspension that can prevents degradation of the phosphor, and so on.

### Means for Solving the Problem

To fulfill the above-mentioned object, the present invention provides a manufacturing method for a phosphor suspension to be applied to an inner surface of a glass bulb of a fluorescent lamp, the manufacturing method comprising the steps of: kneading a mixture of a phosphor powder and a solvent that includes a thickening agent, while keeping a thick consistency thereof; and adding a metal compound as a coating agent and a solvent that includes a thickening agent and a binding agent to the kneaded mixture, and agitating the mixture.

### ADVANTAGEOUS EFFECT OF THE PRESENT INVENTION

With the stated structure, the phosphor particles are densely arranged due to the thick-consistency kneading, and the contacting area between the phosphor particles and the inner surface of the glass bulb is large. Accordingly, it is possible to secure a required adherability. In addition, since the phosphor particles are coated with the metal compound, it is possible to suppress degradation of the phosphor particles.

The metal compound may be an yttrium compound.

With the stated structure, since the wall thickness is 0.5 mm or less, it is possible to secure required adherability even in the case of a fluorescent lamp with a phosphor layer that readily peels off.

A fluorescent lamp pertaining to the present invention includes a glass bulb, and a phosphor layer formed on an inner surface of the glass bulb, wherein the phosphor layer includes a plurality of phosphor particles each coated with a metal oxide, and the number of phosphor particles contacting the inner surface of the glass bulb, counted along a circumference of a cross section of the glass bulb, is in a range of 0.150/μm to 0.190/μm inclusive.

With the stated structure, since the number of the contacting particles is large (i.e. the contacting area between the phosphor particles and the inner surface of the glass bulb is large), it is possible to secure the adherability of the phosphor particles. In addition, since the phosphor particles are coated with the metal oxide, it is possible to prevent degradation of the phosphor particles.

The wall thickness of the glass bulb may be 0.5 mm or less.

A backlight unit pertaining to the present invention includes the fluorescent lamp as a light source.

A liquid crystal display apparatus pertaining to the present invention includes a liquid crystal display panel and the backlight unit.

The phosphor layer may include three types of phosphor particles, the three types of phosphor particles being red phosphor particles, green phosphor particles and blue phosphor particles that are excited by ultraviolet radiation to emit red light, green light and blue light respectively, and at least two types of phosphor particles from among the three types of phosphor particles may have a property of absorbing ultraviolet radiation with a wavelength of 313 nm.

With the stated structure, given that 313-nm ultraviolet radiation generated during discharge is absorbed in the phosphor layer, it is possible to prevent 313-nm ultraviolet radiation from leaking out of the lamp without forming a separate coating for blocking ultraviolet radiation as is conventionally done. For this reason, if the fluorescent lamp of the present invention is used in, for example, a backlight unit, degradation to constituent elements of the backlight unit due to 313-nm ultraviolet radiation can be suppressed.

Also, one of the at least two types of phosphor particles that absorb ultraviolet radiation with a wavelength of 313 nm may be the blue phosphor particles, and the blue phosphor particles may be Eu-activated barium magnesium aluminate phosphor particles.

Also, one of the at least two types of phosphor particles that absorb ultraviolet radiation with a wavelength of 313 nm may be the green phosphor particles, and the green phosphor particles may be Eu and Mn activated barium magnesium aluminate phosphor particles.

Also, the at least two types of phosphor particles may compose 50% or more by weight of a total weight composition of the three types of phosphor particles.

Also, a thickness of the phosphor layer may be in a range of 14 μm to 25 μm inclusive.

Also, the glass bulb may be borosilicate glass which has a property of absorbing ultraviolet radiation with a wavelength of 254 nm.

Also, yttrium oxide protective films may have been formed between the phosphor particles and on surfaces thereof.

Also, the backlight unit of Claim 15 pertaining to the present invention may include the fluorescent lamp of Claim 8 as a light source.

Also, a liquid crystal display apparatus pertaining to the present invention may include a liquid crystal display panel; and the backlight unit of Claim 15.

A direct-type backlight unit pertaining to the present invention includes a plurality of the fluorescent lamps of Claim 8; and a diffusion plate disposed on a light extracting side, and being a polycarbonate resin.

### BRIEF DESCRIPTION OF THE DRAWINGS

FIG. 1 is a longitudinal cross-sectional view schematically showing the structure of a cold-cathode fluorescent lamp 10;

FIG. 2A is an enlarged schematic diagram of a phosphor layer 22 pertaining to an embodiment of the present invention, and FIG. 2B is an enlarged schematic diagram of a conventional phosphor layer 1022 formed without using a thick-consistency kneading method;

FIG. 3A schematically shows an influence of a glass tube 12 on a phosphor 24, and FIG. 3B schematically shows the structure of the phosphor 24;

FIG. 4 schematically shows a process for manufacturing a phosphor suspension;

FIG. 5A and FIG. 5B are SEM photographs of a phosphor layer, where FIG. 5A is a photograph of a phosphor layer 22 pertaining to an embodiment of the present invention, and FIG. 5B is a photograph of a phosphor layer formed from a phosphor suspension manufactured without using the thick-consistency kneading method;

FIG. 6 is a cross-sectional view schematically showing the structure of a liquid crystal display apparatus 50;

FIG. 7 is a flowchart showing a first color adjustment method;

FIG. 8 is a flowchart showing a second color adjustment method;

FIG. 9 shows a partially cut-out view showing the structure of a cold-cathode fluorescent lamp 120 pertaining to the second embodiment of the present invention, and a partially enlarged view of a phosphor layer;

FIG. 10A and FIG. 10B are tables that show names of the three types of phosphors, whether they absorb ultraviolet radiation with a wavelength of 313 nm, and total weight proportions, FIG. 10A showing an example of phosphors pertaining to conventional technology, and FIG. 10B showing phosphors pertaining to embodiment 2

FIG. 11 is a graph showing results of an experiment that examined how an effect blocking ultraviolet radiation is influenced by proportions of phosphors absorbing 313-nm ultraviolet radiation to a total weight of phosphors;

FIG. 12A and FIG. 12B show a structure of an external electrode fluorescent lamp 150 pertaining to embodiment 2, FIG. 12A schematically showing the external electrode fluorescent lamp 150, and FIG. 12B being an enlarged cross-sectional view, along a tube axis, of an end of the external electrode fluorescent lamp 150.

FIG. 13 a schematic perspective view showing a structure of a direct-type backlight unit 1 pertaining to embodiment 2;

FIG. 14 is a cross-sectional view showing a schematic structure of an edge-light backlight unit 200;

FIG. 15 a graph showing changes in an amount of moisture residue with time in the sintering step; and

FIG. 16 shows a cross section of the phosphor layer.

### EXPLANATION OF REFERENCES

10, 120 cold-cathode fluorescent lamp
12, 130, 160 glass bulb (glass container)
22, 132, 164, 173 phosphor layer
24 phosphor
26 phosphor particle
28 coating layer
32 a small amount of butyl acetate solvent including a thickening agent (nitrocellulose)
40 butyl acetate solvent including a thickening agent (nitrocellulose) and a binding agent (CBB)
42 coating agent
50 liquid crystal display apparatus
60 liquid crystal panel
70, 200 edge-light backlight unit
100 direct-type backlight unit
113 diffusion plate
132B, 164B blue phosphor particles
132G, 164G green phosphor particles
132R, 164R red phosphor particles
150 external electrode fluorescent lamp
176 yttrium oxide coating (protective coating)

### BEST MODE FOR CARRYING OUT THE INVENTION

### 1. Embodiment 1

The following explains an embodiment of the present invention with reference to the drawings.

### 1.1 Structure of Cold-Cathode Fluorescent Lamp

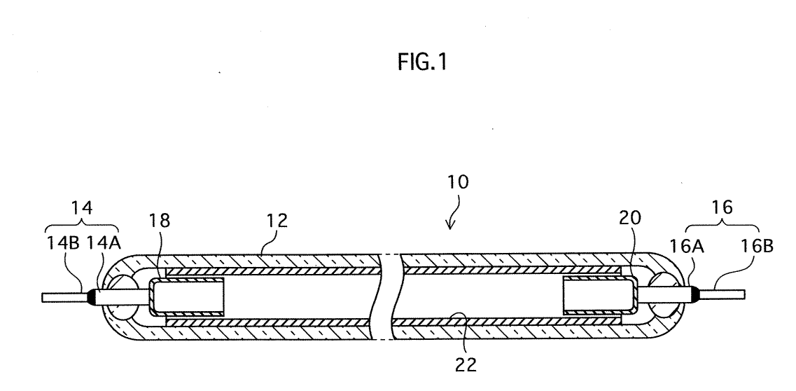

FIG. 1 is a longitudinal cross-sectional view schematically showing the structure of a cold-cathode fluorescent lamp pertaining to an embodiment of the present invention.

A cold-cathode fluorescent lamp 10 has a glass bulb 12 in a straight tubular shape. The glass bulb 12 is made of hard borosilicate glass, where the total length is 450 mm, the outer diameter is 2.4 mm, the inner diameter is 2.0, and the wall thickness is as thin as 0.2 mm. This wall thickness is not that of the both ends of the glass tube 12, but that of the straight tube part of the glass bulb 12.

The glass bulb 12 readily warps, because it is long and has a thin wall thickness. Therefore, the adherability of the phosphor layer is required to prevent the layer from peeling off due to the warpage.

Lead wires 14 and 16 are sealed in ends of the glass bulb 12. The lead wires 14 and 16 are lines respectively composed of an inner lead wire 14A (16A) formed from tungsten, and an outer lead wire 14B (16B) formed from nickel. Electrodes 18 and 20 are respectively fixed to end parts of the inner lead wires 14A and 16A existing within the glass bulb 12, using laser welding or the like.

The electrodes 18 and 20 are so-called hollow electrodes which are cylindrical and have a bottom, which have been manufactured by processing niobium rods. Here, the reason for using a hollow electrode is its effectiveness in suppressing sputtering at the electrode, which occurs due to discharge during lamp operation (For details, see Japanese Laid-open Patent Application Publication No. 2002-289138).

Rare gases such as mercury, argon, neon, etc. are enclosed within the glass bulb 12 at a predetermined pressure.

Also, a phosphor layer 22 having a thickness of approximately 18 μm is formed on the inside surface of the glass bulb 12. The phosphor layer 22 is formed by applying a phosphor suspension to the inside surface of the glass tube 12 and subjecting the phosphor suspension to drying and baking processes.

As described later, since the phosphor layer 22 is manufactured using a phosphor suspension processed through the thick-consistency kneading method, the phosphors 24 are arranged densely.

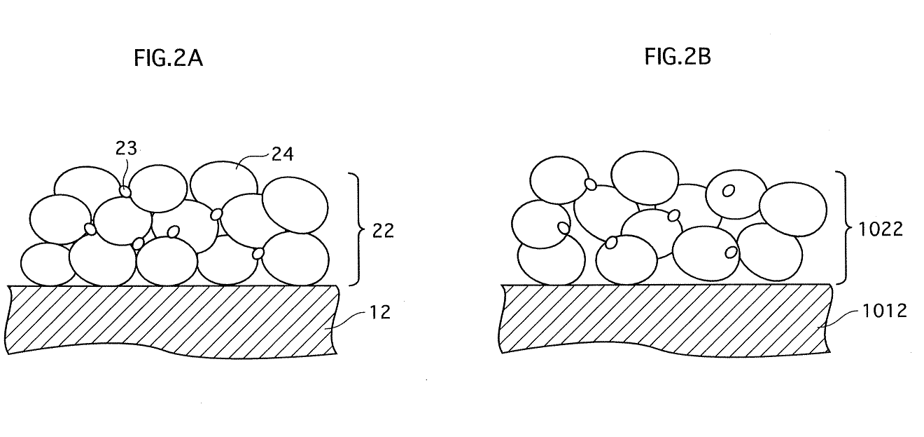

FIG. 2A is an enlarged schematic diagram of the phosphor layer 22 pertaining to this embodiment of the present invention.

A binding agent 23 is consisted of CBB (alkaline earth metal borate) and binds the phosphors 24 together.

For comparison use, FIG. 2B shows an enlarged schematic diagram of a conventional phosphor layer 1022 formed without using the thick-consistency kneading method.

As FIG. 2A and FIG. 2B clearly show, in the phosphor layer 22 pertaining to the embodiment 1 of the present invention, the phosphor particles 24 are arranged more densely than in the phosphor layer 1022 formed without using the thick-consistency kneading method.

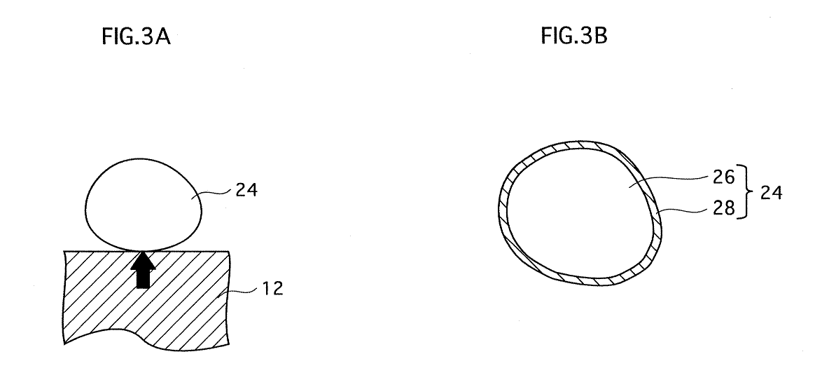

Meanwhile, since the phosphor layer 22 has a large contact area with the glass bulb 12, it readily reacts with the material of the glass bulb 12 (Na, etc.). In FIG. 3A, the arrow represents the effect of the glass bulb 12 against the phosphor 24.

As FIG. 3B shows, the phosphor 24 pertaining to the embodiment 1 of the present invention includes a phosphor particle 26 and a coating layer 28 that is yttrium oxide coating on the surface of the phosphor particle 26. This coating layer 28 prevents the phosphor particle 26 from directly contacting the glass bulb 12, and eroding.

### 1.2 Manufacturing Method for Phosphor Suspension

The phosphor layer is manufactured through the following processes: (A) manufacturing a phosphor suspension; (B) applying the manufactured phosphor suspension to the glass bulb; (C) drying; and (D) sintering (baking).

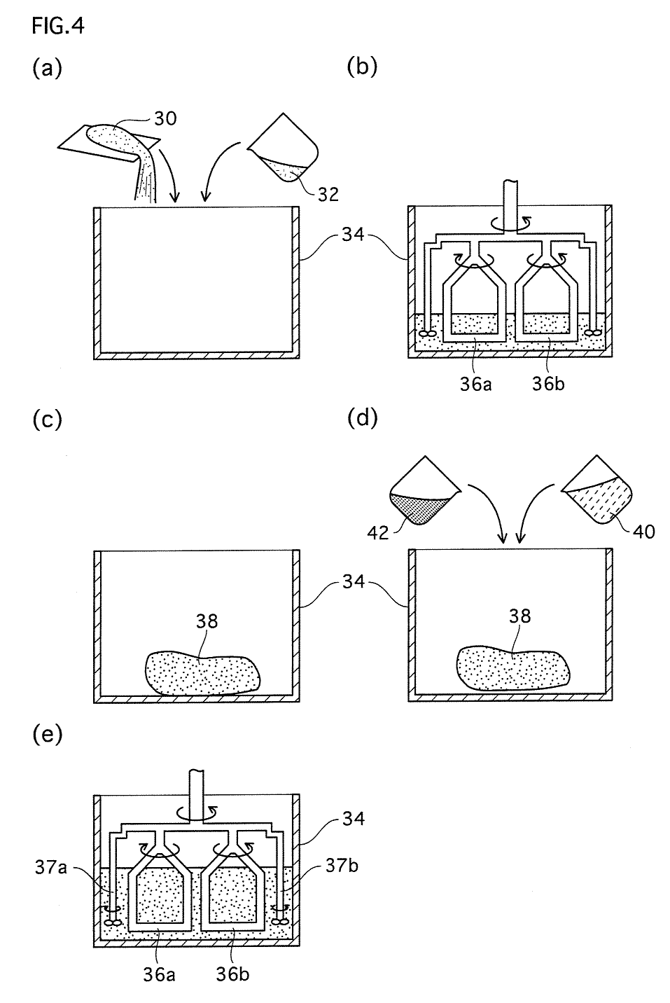

The following describes the process for (A) manufacturing a phosphor suspension, with reference to FIG. 4.

FIG. 4 schematically shows a process for manufacturing a phosphor suspension.

Firstly, a phosphor powder 30 and a small amount of butylacetate solvent 32 that includes 2-4% by weight of a total weight composition of nitrocellulose as the thickening agent are put into a tank [FIG. 4A].

A mixture ratio of these materials is adjusted to keep a certain viscosity, for example, 100 g of the phosphor powder 30 and 10 to 30 g of the solvent 32.

Regarding the phosphor power 30, BaMg₂Al₁₆O₂₇:Eu²⁺ (BAM, europium-activated barium magnesium aluminate phosphor) is used as the blue phosphor, LaPO₄:Ce³⁺,Tb³⁺ (LAP, cerium and terbium activated lanthanum phosphate phosphor) is used as the green phosphor, and Y₂O₃:Eu³⁺ (YOX, europium-activated yttrium oxide phosphor) is used as the red phosphor, for example.

Next, the thick-consistency kneading is performed for 10 minutes by rotating blades 36a and 36b [FIG. 4B]. These blades 36a and 36b perform sun-and-planet motion including revolution and rotation.

The phosphor powder 30 and the solvent 32 are gradually mixed through the thick-consistency kneading to obtain a semisolid 38. This semisolid 38 will be continuously subject to the thick-consistency kneading. As a result, due to the attrition by the blades 36a and 36b, it is possible to decompose an agglomeration of phosphor particles into primary particles.

After the thick-consistency kneading is performed [FIG. 4C], a butyl acetate solvent 40 including CBB as a binding agent and nitrocellulose, and a coating agent 42 including yttrium caprylate [(C₇H₁₅COO)₃Y] are put into the tank [FIG. 4D].

Next, the blades 36a and 36b are rotated to agitate the mixture [FIG. 4E].

During the agitation, the phosphor particles are coated with the yttrium caprylate. Then, during the following sintering process, the phosphor particles are coated with yttrium oxide as the following chemical formula:

Y(C₇H₁₅COO)₃+H₂O→Y—(OH)₃+3C₇H₁₅COOH→Y₂O₃+H₂O+CO₂

In the manufactured phosphor suspension, the phosphor particles are crushed into primary particles. For this reason, the phosphor particles included in the phosphor layer formed after application of the phosphor suspension can be densely arranged.

Due to this dense arrangement, the adherability between the phosphor layer and the inside surface of the glass bulb can be ensured. Also, it is possible to prevent the mercury enclosed within the glass bulb from getting through the gaps between the phosphor particles and staying there.

Also, the phosphor particles react with the material of the glass bulb 12 (Na, etc.) and become degraded, and sometimes causes a color shift in the light emitted by the lamp. According to the embodiment 1, since the phosphor particles are coated with yttrium oxide, it is possible to suppress the reaction between the phosphor particles and the glass bulb material.

### 1.3 Micrograph of Phosphor Layer

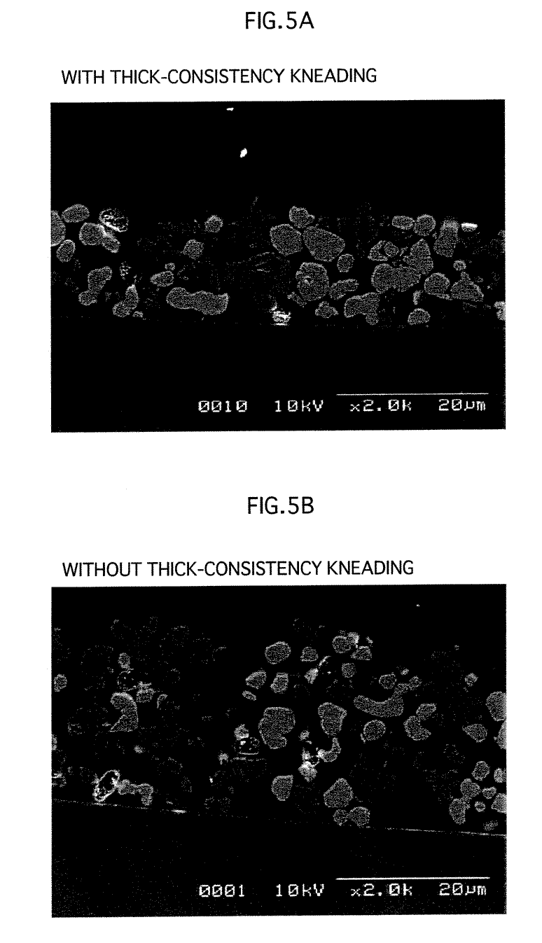

FIG. 5A and FIG. 5B are SEM photographs of the phosphor layer. FIG. 5A is a photograph of the phosphor layer 22 pertaining to the embodiment 1 of the present invention, and FIG. 5B is a photograph of a phosphor layer formed from a phosphor suspension manufactured without using the thick-consistency kneading method.

These phosphor layers have been formed by applying the same amount of a phosphor suspension with the same composition to a glass bulb with the same size (a total length of 400 mm, an outer diameter of 2.4 mm and an inner diameter of 2.0 mm).

The pictures show an inner surface of the cross section of each glass bulb cut at the substantial center in the longitudinal direction.

As FIG. 5A and FIG. 5B clearly show, compared to the phosphor layer manufactured without use of the thick-consistency kneading method (FIG. 5B), the phosphor particles included in the phosphor layer manufactured with use of the thick-consistency kneading method (FIG. 5A) are arranged densely, and the film thickness thereof is thin.

Specifically, the inventors put a plurality of such pictures together and counted the number of phosphors that contacts the glass in the range of 291 μm of the circumference of the glass bulb. For example, in the case where the thick-consistency kneading method is not used, the number is 41 (41/291 μm=0.141/μm), and in the case where the thick-consistency kneading method is used, the number is 48 (48/291 μm=0.165/μm).

As described above, although the phosphor layer manufactured with use of the thick-consistency kneading method has an advantage that a strong adherability is ensured due to the dense arrangement, the phosphor particles readily react with the glass bulb material (Na, etc.) and become degraded due to the large contacting area between the phosphor particles and the inner surface of the glass bulb (i.e. due to the large number of phosphor particles that contact the glass bulb).

Since the phosphor particles pertaining to this embodiment of the present invention are coated with yttrium oxide, they are prevented from reacting with the glass bulb material and becoming degraded.

It should be noted here that the inventors confirmed that if phosphor particles of a common type are used in manufacturing the phosphor layer with use of the thick-consistency kneading method, the number of the phosphor particles falls within the range from 0.150/μm to 0.190 μm.

### 1.4 Liquid Crystal Display Apparatus

The cold-cathode fluorescent lamp 10 pertaining to the embodiment 1 may be used for a liquid crystal display apparatus.

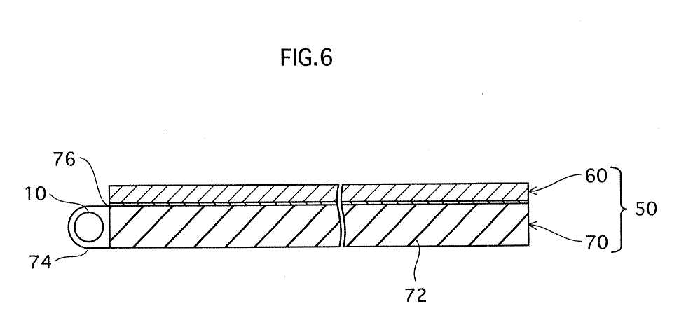

FIG. 6 is a cross-sectional view of a liquid crystal display apparatus 50.

The liquid crystal display apparatus 50 includes a liquid crystal display panel 60 and an edge-light backlight unit 70 mounted on the back surface of the liquid crystal display panel 60.

The backlight unit 70 includes a light guide plate 72 made from translucent acrylic resin, the cold-cathode fluorescent lamp 10 provided at an end face of the light guide plate 72, a reflecting plate 74 that reflects light emitted from the cold-cathode fluorescent lamp 10 toward the light guide plate 72, and a luminance-improvement sheet 76 provided on a principal surface of the light guide plate 72.

In the cold-cathode fluorescent lamp 10 pertaining to this embodiment, the adherability of the phosphor layer is secured and prevented from becoming degraded, in spite of the thin wall thereof. Accordingly, the cold-cathode fluorescent lamp 10 contributes to a reduced thickness and a long life of the backlight unit.

In particular, the cold-cathode fluorescent lamp 10 is suitable as a light source for a backlight unit for mobile apparatuses that are demanded to be thinner on the order of millimeters.

### 1.5 Other

### 1.5.1 Metal Oxide

In this embodiment, yttrium is taken as an example for metal oxide coated on the surfaces of phosphor particles. However, other metal oxides may be used, such as silicon dioxide, aluminum oxide, hafnium oxide, zirconium oxide, vanadium oxide, niobium oxide, and yttrium oxide.

### 1.5.2 Coating Agent

As a coating agent, (CₙH₂ₙ₊₁COO)₃Y (n=1-10), yttrium 2-ethylhexanoate, yttrium carbonate, yttrium oxalate may be used to achieve the same effect.

### 1.5.3 Manufacturing Phosphor Suspension

The embodiment 1 is not limited to the method with use of the thick-consistency kneading method described above. For example, a roll mill, a ball mill, a homomixer or the like may be used. Also, if the number of the phosphor particles is within a range from 0.150/μm to 0.190/μm due to any phosphor surface processing, it is possible to obtain the effect of the yttrium oxide.

### 1.5.4 Color Adjustment

Although not described in the embodiment 1 in detail, the following methods A and B are available for color adjustment.

### A. Adjustment Method 1

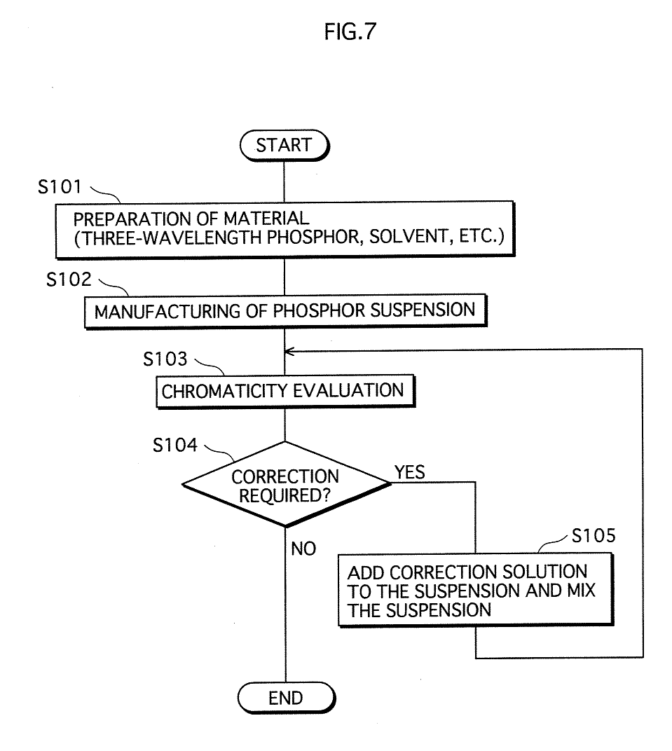

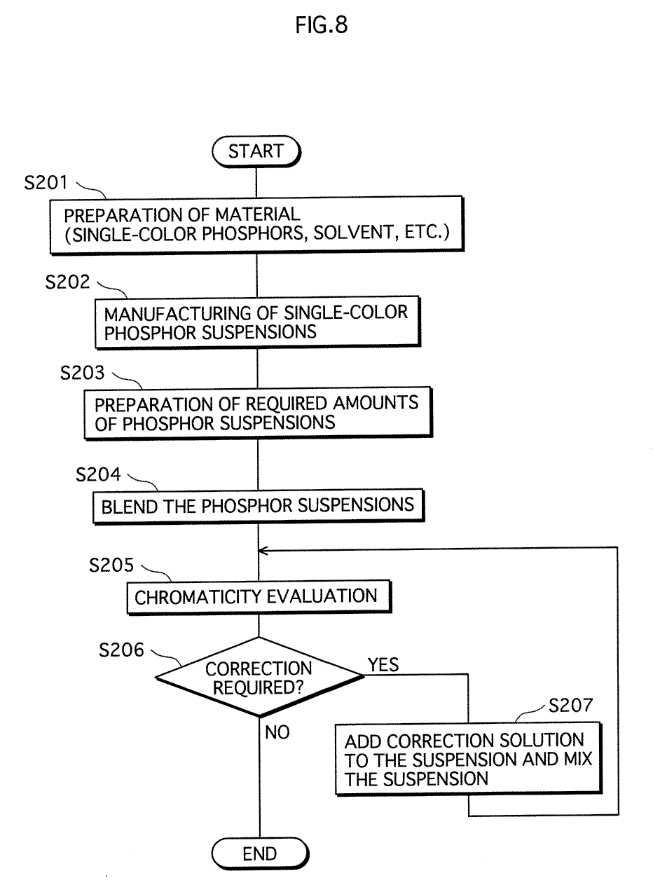

FIG. 7 is a flowchart showing an adjustment method 1. The adjustment method 1 includes the steps of:

firstly, weighing a solvent including three-wavelength (or four-wavelength) phosphor, a thickening agent and a binding agent (S101), and manufacturing a phosphor suspension (S102);

Then, manufacturing sample lamps for testing chromaticity using the phosphor suspension, and operating the lamps for chromaticity evaluation (S103); if the evaluated chromaticity is within a targeted range and color correction is not required (S104: No), the routine of the color adjustment is finished; and if correction is required (S104: Yes), adding a correction solution to the phosphor suspension for color correction (S105).

The correction solution is a phosphor suspension that includes a single-color phosphor.

### B. Adjustment Method 2

FIG. 7 is a flowchart showing an adjustment method 2. The adjustment method 2 includes the steps of:

firstly, weighing a solvent including a single-color phosphor, a thickening agent and a binding agent (S201); manufacturing a single-color phosphor suspension for each color (S202);

preparing required amounts of the manufactured single-color phosphor suspensions (S203); and blending (mixing) the single-color phosphor suspensions (S204).

In the case of blending the single-color phosphor suspensions that have been prepared in advance, the same effect of the thick-consistency kneading and the yttrium oxide coating can be obtained as in the adjustment method 1. If this is the case, it is unnecessary to additionally prepare a single-color correction solution. This results in high efficiency in the manufacturing.

The subsequent steps S205-S207 are the same as the steps S103-S105 (See FIG. 7).

### 1.5.5 Lamp Types

In the embodiment 1, the cold-cathode fluorescent lamp is explained as an example. However, the present invention is not limited to this, and applicable to a hot-cathode fluorescent lamp and an EEFL (external electrode fluorescent lamp).

### 1.5.6 Coating

In the embodiment 1, the phosphor particle 26 is coated with the coating layer 28 continuously (continuous layer) as FIG. 3B shows. However, the present invention is not limited to this. Fine particles of metal may be attached to the surface of the phosphor particle 26 (non-continuous layer).

In the example shown in FIG. 3B, the whole surface of the phosphor particle 26 is coated with the coating layer 28. However, it is not necessary that the whole surface is coated with the coating layer 28 (Part of the phosphor particle 26 may be exposed).

### 1.5.7 Number of Phosphor Particles in Contact

The above-described range of the number of phosphor particles that contact the glass bulb is different when different phosphor material is used. For example, to realize higher color reproducibility, europium-activated yttrium vanadate phosphor as red phosphor particles, europium and manganese activated barium magnesium aluminate as green phosphor particles, and europium-activated barium magnesium aluminate as blue phosphor particles may be used.

In this case, the inventors of the present invention found that the number of the contacting phosphor particles is in the range from 0.23/μm to 0.35/μm.

### 2. Embodiment 2

### 2.1 Structure of Cold-Cathode Fluorescent Lamp

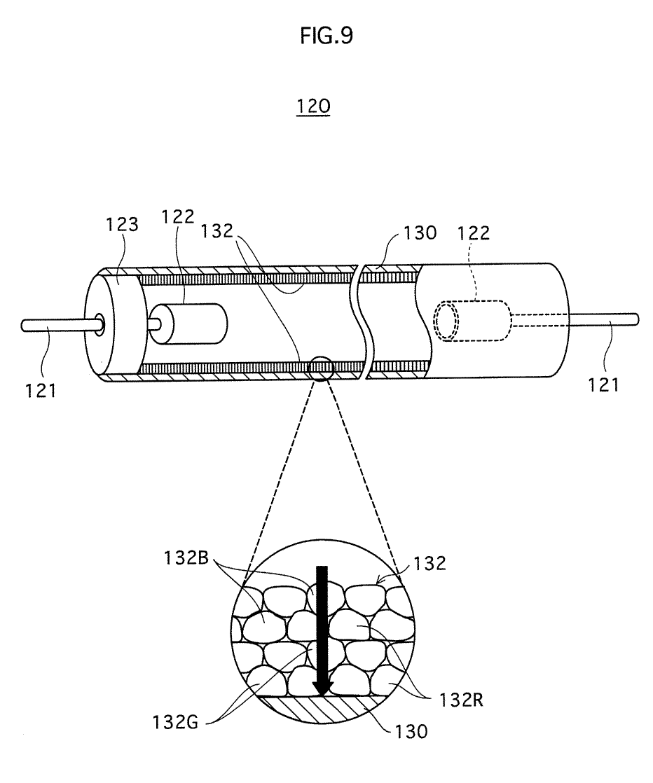

The following explains the structure of a cold-cathode fluorescent lamp 120 pertaining to the embodiment 2, with reference to FIG. 9. FIG. 9 is a partially cutout view showing a schematic structure of the cold-cathode fluorescent lamp 120, and a partially enlarged view of a phosphor layer.

The cold-cathode fluorescent lamp 120 has a glass bulb 130 that is a straight tube having a substantially circular cross-section. The glass bulb 130 is composed of, for example, borosilicate glass. Note that the glass bulb 130 has a length of 720 mm, an outer diameter of 4.0 mm, and an inner diameter of 3.0 mm.

Note that it is preferable the outer diameter is within a range from 1.6 mm (with an inner diameter 1.2 mm) to 6.5 mm (with an inner diameter 5.5 mm).

If the wall thickness of the glass bulb is thin (e.g. not more than 0.5 mm), the glass bulb 130 readily warps. Accordingly, it is necessary to improve the adherability of the phosphor layer.

Lead wires 121 are sealed in ends of the glass bulb 130 via a bead glass 123. The lead wires 21 are continuous lines composed of, for example, an inner lead wire formed from tungsten, and an outer lead wire formed from nickel. An end of each of the inner lead wires 121 is fixed to a cold-cathode electrode 122.

Note that the interior of the glass bulb 130 is sealed as a result of the bead glass 123 and the glass bulb 130 being fused together, and the bead glass 123 and the lead wires 121 being affixed by the frit glass. Also, the electrodes 122 and the lead wires 121 are affixed using laser welding or the like.

The electrodes 122 are formed from niobium (or nickel), and are so-called hollow electrodes which are cylindrical and have a bottom. Here, the reason for using a hollow electrode is its effectiveness in suppressing sputtering at the electrode, which occurs due to discharge during operation.

Mercury is enclosed inside the glass bulb 130 at a predetermined amount per volume of the glass bulb 130, such as 0.6 mg/cc. Rare gases such as argon (Ar), neon (Ne), etc. are enclosed in the interior of the glass bulb 130 at a predetermined pressure such as 60 Torr.

Note that here, the rare gas is a mixed gas containing argon (Ar) and neon (Ne) at a ratio of 5% Ar to 95% Ne.

A phosphor layer 132 is excited by ultraviolet radiation emitted from the mercury, and includes phosphors 132R, 132G, and 132B, which are three types of phosphors that convert the ultraviolet radiation into red, green, and blue light respectively.

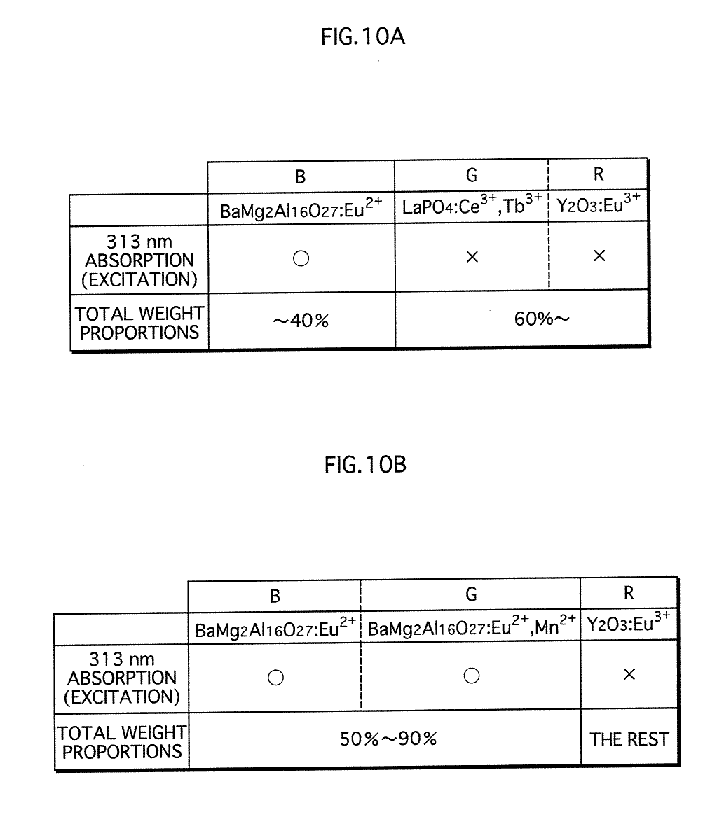

FIG. 10A and FIG. 10B are tables that show names of the three types of phosphors, whether they absorb ultraviolet radiation with a wavelength of 313 nm, and total weight proportions. FIG. 1A shows an example of phosphors pertaining to conventional technology, and FIG. 10B shows phosphors pertaining to the present embodiment.

As shown in FIG. 10A, BaMg₂Al₁₆O)₇:Eu²⁺ (BAM) is used as the conventional blue phosphor, LaPO₄:Ce³⁺,Tb³⁺ (LAP) is used as the conventional green phosphor, and Y₂O₃:Eu³⁺ (YOX) is used as the conventional red phosphor. Out of these three types of phosphors, only the blue phosphor BAM has the property of absorbing 313-nm ultraviolet radiation (i.e. only the blue phosphor BAM is excited by 313-nm ultraviolet radiation).

The total weight proportions of the three types of phosphors are determined according to the required color temperature, and the total weight proportion of BAM phosphor is at most roughly 40%. It is for this reason that 313-nm ultraviolet radiation leaks out of the glass bulb in conventional cold-cathode fluorescent lamps.

In contrast, as shown in FIG. 10B, BaMg₂Al₁₆O₂₇:Eu²⁺,Mn²⁺ (BAM: Eu and Mn activated barium magnesium aluminate phosphor) is used as green phosphor particles in the present embodiment. Similarly to the blue phosphor BAM, this green phosphor has the property of absorbing 313-nm ultraviolet radiation. In this way, given that two types of the phosphor particles have the property of absorbing 313-nm ultraviolet radiation, 313-nm ultraviolet radiation is absorbed in the phosphor layer 132 (ultraviolet radiation is prevented from reaching the glass bulb 130), and 313-nm ultraviolet radiation is prevented from leaking out of the glass bulb 130 (out of the cold-cathode fluorescent lamp 120).

313-nm ultraviolet radiation is shown as a black arrow in the enlarged view at the bottom of FIG. 9. The 313-nm ultraviolet radiation is blocked by the phosphor layer 132, and fails to reach the glass bulb 130. It is therefore possible to suppress solarization of the glass bulb 130 as well.

### 2.2 Preferred Proportions of Phosphors Absorbing 313-nm Ultraviolet Radiation

Next is a description of an experiment that examined how the effect of blocking ultraviolet radiation is influenced by the proportion of the phosphors absorbing 313-nm ultraviolet radiation to the total weight of the phosphors.

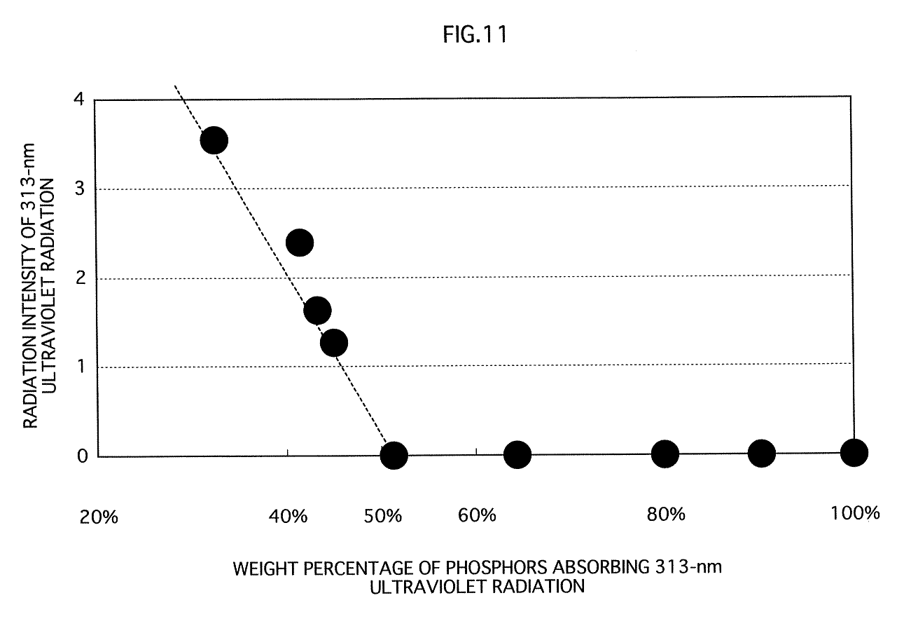

FIG. 11 is a graph showing results of the experiment. In the graph, a horizontal axis represents a weight percentage (%) of the phosphors absorbing 313-nm ultraviolet radiation, while a vertical axis represents a radiation intensity (arbitrary unit) of 313-nm ultraviolet radiation.

The experiment was performed by applying a constant current of 6 mA to turn on a lamp (with an outer diameter of 3 mm and an inner diameter of 2 mm) with the same structure as the cold-cathode fluorescent lamp 120 described using FIG. 9, and measuring the intensity of 313-nm ultraviolet radiation that was emitted out of the lamp, at a center of the lamp in the longitudinal direction.

A thickness of the phosphor layer of the lamp used in the measurement was from 14 μm to 25 μm. A method for measuring thickness is mentioned later.

As shown in the graph of FIG. 11, it is understood that the blocking effect becomes larger as the total weight proportion of phosphors absorbing 313-nm ultraviolet radiation is increased, and in particular, 313-nm ultraviolet radiation was significantly prevented from leaking out of the lamp when the proportion was 50% or more. Note that although it appears in the graph that the intensity of 313-nm ultraviolet radiation is zero when the above proportion is 50% or more, the radiation intensity is not actually zero, but rather a minute amount of radiation intensity was measured.

Also, a phosphor absorbing 313-nm ultraviolet radiation in the present embodiment is defined as a phosphor in which an intensity of an excitation wavelength spectrum of 313 nm is 80% or more when an intensity of an excitation wavelength spectrum around 254 nm is 100% (the excitation wavelength spectrum is a type of spectrum that plots an excitation wavelength and a light intensity when a phosphor is excited over a range of wavelengths, relative to an excitation wavelength at a maximum peak as 100). In other words, a phosphor absorbing 313-nm ultraviolet radiation is a phosphor capable of absorbing 313-nm ultraviolet radiation and converting it to visible light.

Note that, in the case of using blue and green phosphors that absorb 313-nm ultraviolet radiation as shown in FIG. 10B, 90% is an upper limit of the total weight proportion of these phosphors. However, this upper limit value can change according to a chromaticity to be set when mixing the three colors of phosphors.

### 2.3 Structure of External Electrode Fluorescent Lamp

The present invention can be applied to not only a cold-cathode fluorescent lamp, but also an external electrode fluorescent lamp.

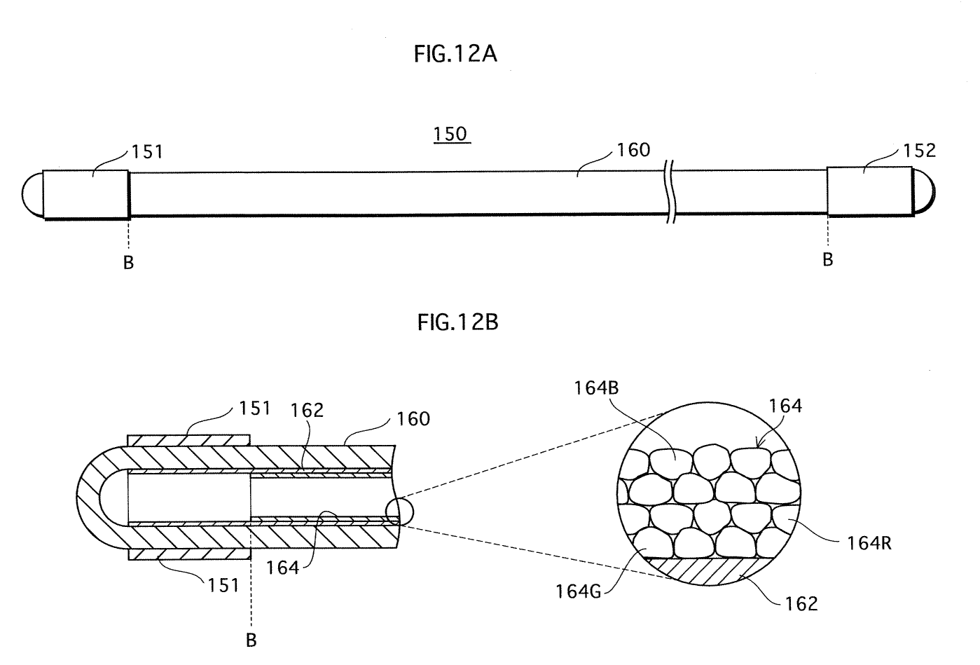

FIGS. 12A and 12B show a structure of an external electrode fluorescent lamp 150 pertaining to the embodiment 2. FIG. 12A schematically shows the external electrode fluorescent lamp 150, and FIG. 12B is an enlarged cross-sectional view, along a tube axis, of an end of the external electrode fluorescent lamp 150.

As shown in FIG. 12A, the external electrode fluorescent lamp 150 includes a glass bulb 160 composed of a straight-tube cylindrical glass tube that is sealed at both ends, and external electrodes 151 and 152 that have been formed around an outer circumference of the ends of the glass bulb 160.

The glass bulb 160 is composed of, for example, borosilicate glass, and a cross-section thereof is substantially circular. The external electrodes 151 and 152 are composed of aluminum metal foil, and are affixed to the glass bulb 160 using a conductive adhesive including a silicone resin and a metal powder, so as to cover the outer circumferences of the ends of the glass bulb 160.

Note that the glass bulb 160 is not limited to borosilicate glass. Lead glass, lead-free glass, soda glass, or the like may be used. In this case, it is possible to improve an in-dark starting characteristic of the lamp. Specifically, glasses such as the above contain a large amount of alkali metal oxides such as sodium oxide (Na₂O), and in the exemplary case of sodium oxide, the sodium (Na) component elutes to the inner side of the glass bulb over time. The sodium that elutes to the inner ends of the glass bulb (without a protective film) is thought to contribute to improvement in the in-dark starting characteristic since sodium has a low electronegativity.

Particularly in external electrode fluorescent lamps in which external electrodes are formed so as to cover outer circumferences of the ends of the glass bulb, it is preferable for 3 mol % to 20 mol % of alkali metal oxides to be included in the glass bulb material.

For example, if the alkali metal oxide is yttrium oxide, it is preferable for 5 mol % to 20 mol % of yttrium oxide to be included in the glass bulb material. If the yttrium oxide content is less than 5 mol %, there is a higher probability that the in-dark starting time will exceed one second (in other words, there is a higher probability that the in-dark starting time will be less than one second if the yttrium oxide content is 5 mol % or more). If the yttrium oxide content is more than 20 mol %, there may be problems such as reduced luminance from whitening of the glass bulb due to long-term use, and a reduction in the strength of the glass bulb.

Also, it is preferable to use lead-free glass if environmental protection is taken into consideration. However, lead-free glass may acquire lead as an impurity in the manufacturing process. Lead-free glass is therefore defined as glass that contains lead at an impurity level of 0.1% by weight or less.

Note that fluoride resin, polyimide resin, an epoxy resin, etc. may be used as the conductive adhesive, instead of silicone resin. Also, instead of affixing the metal foil to the glass bulb 160 using the conductive adhesive, the external electrodes 151 and 152 may be formed by applying a silver paste around an entire circumference of electrode formation portions of the glass bulb 160. Furthermore, the external electrodes 151 and 152 may be given a cylindrical shape, or may be made caps that cover the ends of the glass bulb 160.

As shown in FIG. 12B, a protective layer 162 composed of, for example, yttrium oxide (Y₂O₃) is formed on an inner side of the glass bulb 160. The protective layer 162 functions to suppress a reaction between the glass bulb 160 and the mercury that is enclosed therein.

A phosphor layer 164 is deposited on the protective layer 162. As shown in FIG. 12A, assuming that positions of inner ends of the external electrodes 151 and 152 are B, the phosphor layer 164 is formed in an area corresponding to B-B of the glass bulb 160.

In the phosphor layer 164, BaMg₂Al₁₆O₂₇:Eu²⁺ (BAM) is used as blue phosphors particles 164B, BaMg₂Al₁₆O₂₇:Eu²⁺,Mn²⁺ (BAM:Mn²⁺) is used as green phosphor particles 164G, and Y₂O₃:Eu³⁺ (YOX) is used as red phosphor particles 164R.

### 2.4 Structure of Backlight Unit

The cold-cathode fluorescent lamp 120 pertaining to the present embodiment can be used in a direct-type or edge-light backlight unit.

### 2.4.1 Direct-Type Backlight Unit

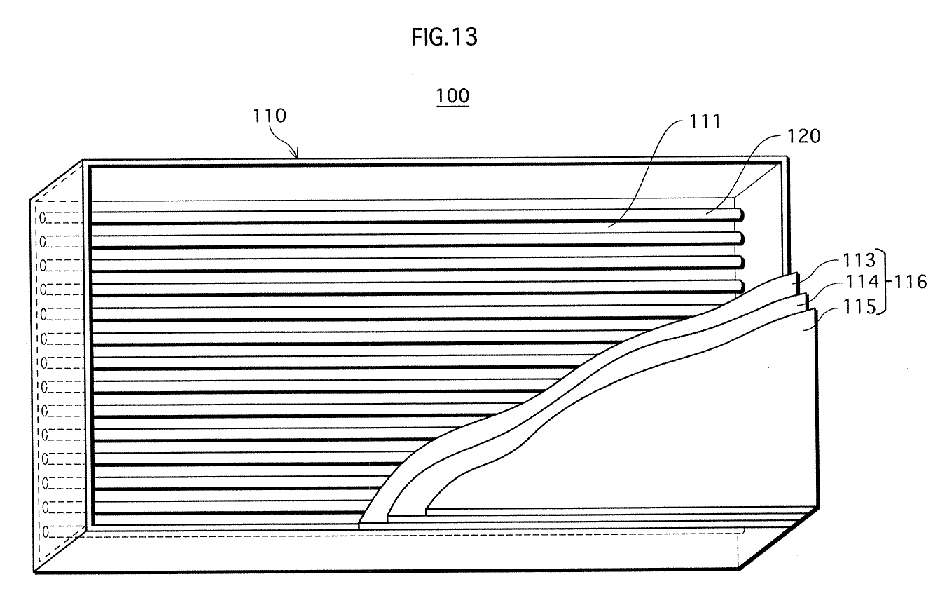

FIG. 13 is a schematic perspective view showing a structure of a direct-type backlight unit 100 pertaining to the embodiment 2. In FIG. 13, a portion of a front panel 116 has been cut away to show an internal construction of the backlight unit 100.

The direct-type backlight unit 100 includes a plurality of cold-cathode fluorescent lamps 120, a housing 110 for storing the fluorescent lamps 120 and which is open on the liquid crystal panel side for extracting light, and the front panel 116 that covers the opening of the housing 110.

The cold-cathode fluorescent lamps 120 are straight tubes, and in the present embodiment, 14 of the cold-cathode fluorescent lamps 120 are disposed parallel in a lateral direction of the housing 110 such that their axes extend horizontally. Note that these cold-cathode fluorescent lamps 120 are turned on using an electronic ballast not depicted in the figure.

The housing 110 is made from polyethylene terephthalate (PET) resin, and a metal such as silver has been vapor deposited on an inner side 111 of the housing 110 to form a reflective surface. Note that the housing 110 may be constituted from a metallic material such as aluminum, instead of a resin.

The opening of the housing 110 is covered by the translucent front panel 116, and is sealed such that foreign substances such as dust and dirt cannot enter the housing 110. The front panel 116 is formed by laminating a diffusion plate 113, a diffusion sheet 114, and a lens sheet 115.

The diffusion plate 113 and the diffusion sheet 114 scatter and diffuse light emitted from the cold-cathode fluorescent lamps 120, and the lens sheet 115 aligns the light in a normal direction of the sheet 115. As a result, the light emitted from the cold-cathode fluorescent lamps 120 radiates evenly across and entirety of a surface (light emitting surface) of the front panel 116.

Note that the diffusion plate 113 is made from a PC (polycarbonate) resin material. PC resin has excellent moisture resistance, mechanical strength, heat resistance, and optical transparency properties, and is often used in diffusion plates for large-screen (e.g., 17 inches or more) liquid crystal display televisions due to the fact that the absorption of moisture causes very little warpage in PC resin plates.

On the other hand, compared to acrylic resin diffusion plates which are used in small liquid crystal display televisions, PC resin readily becomes degraded and discolored due to the affects of ultraviolet radiation.

The inventors of the present invention have confirmed that, whereas there are almost no problems with the affects of 313-nm ultraviolet radiation on acrylic resin diffusion plates, there are cases in which PC resin diffusion plates become significantly degraded and discolored due to 313-nm ultraviolet radiation.

The cold-cathode fluorescent lamps 120 pertaining to the present embodiment can prevent the leakage of 313-nm ultraviolet radiation due to the inclusion of phosphors that absorb 313-nm ultraviolet radiation, and even when using a PC resin diffusion plate which readily degrades due to 313-nm ultraviolet radiation, it is possible to maintain the properties of the diffusion sheet for an extended period of time.

### 2.4.2 Edge-Light Backlight Unit

The cold-cathode fluorescent lamp 120 pertaining to the present invention is applicable not only to direct-type backlight unit, but also to edge-light (light guide plate type) backlight unit.

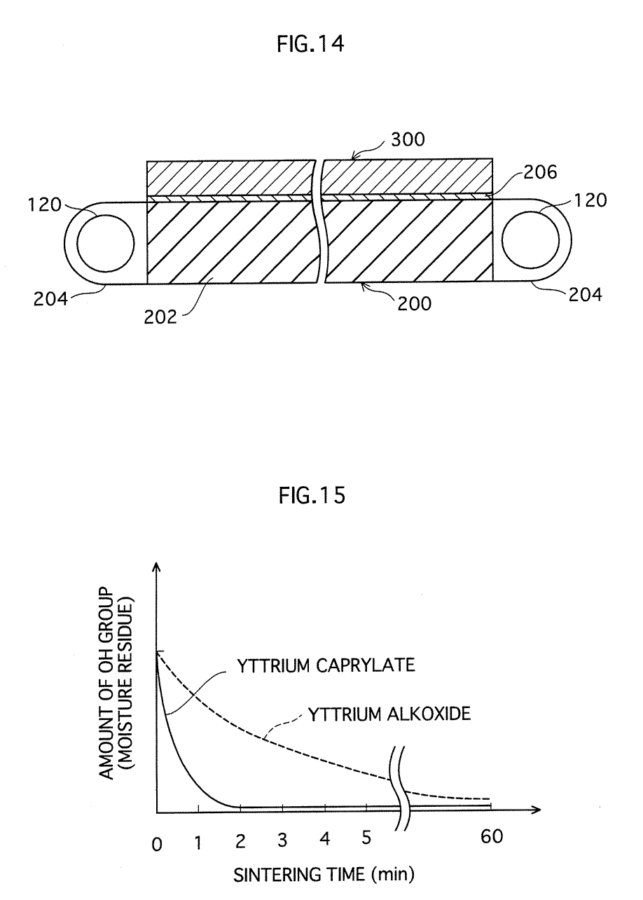

FIG. 14 is a cross-sectional view showing a schematic structure of an edge-light backlight unit 200.

The backlight unit 200 includes a light guide plate 202 made from translucent acrylic resin, two cold-cathode fluorescent lamps 120 provided at end faces of the light guide plate 202, a reflecting plate 204 that reflects light emitted from the cold-cathode fluorescent lamps 120 toward the light guide plate 202, and a sheet layer 206 provided on a principal surface (surface on the light extracting side) of the light guide plate 202.

A liquid crystal panel 300 is disposed on a front face of the backlight unit 200.

The sheet layer 206 is formed by laminating a plurality of sheets such as a prism sheet for improving brightness (e.g., a BEF (Brightness Enhancement Film) manufactured by 3M Corp.), and a light diffusing sheet for enlarging the viewing angle.

There are cases in which a material that readily degrades due to 313-nm ultraviolet radiation is included in the sheets constituting the sheet layer 206. Using the cold-cathode fluorescent lamps 120 of the present embodiment enables suppression of this degradation.

### 2.5 Other

### 2.5.1 Examples of Phosphors Absorbing 313-nm Ultraviolet Radiation

Although the blue and green phosphors have the property of absorbing 313-nm ultraviolet radiation in the present embodiment, a red phosphor having the same property may be also used. Specifically, Y(P,V)O₄:Eu³⁺ or 3.5MgO.0.5MgF₂.GeO₂:Mn⁴⁺ (MFG) may be used as such a red phosphor. The leakage of 313-nm ultraviolet radiation from the lamp can be prevented more effectively if the three types of phosphors all have the property of absorbing 313-nm ultraviolet radiation.

The following are examples of applicable phosphors that have the property of absorbing 313-nm ultraviolet radiation. There are no limitations on the combination of phosphors.

Blue phosphor: BaMg₂Al₁₆O₂₇:Eu²⁺, Sr₁₀(PO₄)₆Cl₂:Eu²⁺, (Sr,Ca,Ba)₁₀(PO₄)₆Cl₂:Eu²⁺, Ba_{1-x-y}Sr_{X}Eu_{y}Mg_{1-z}Mn_{z}Al₁₀O₁₇ (provided that x, y, and z are numbers that satisfy the conditions 0≦x≦0.4, 0.07≦y≦0.25, and 0.1≦z≦0.6, and it is particularly preferable for z to satisfy the condition 0.4≦z≦0.5)

Green phosphor: BaMg₂Al₁₆O₂₇:Eu³⁺,Mn²⁺, MgGa₂O₄:Mn²⁺, CeMgAl₁₁O₁₉:Tb³⁺

Red phosphor: YVO₄:Eu³⁺, YVO₄:Dy³⁺ (emits green and red light)

Note that a mixture of phosphors of different compounds may be used for one color. One example is to use BAM for blue, LAP (does not absorb 313-nm ultraviolet radiation) and BAM:Mn²⁺ for green, and YOX (does not absorb 313-nm ultraviolet radiation) and YVO₄:Eu³⁺ for red. In such a case, the leakage of ultraviolet radiation from the glass bulb can be reliably prevented by adjusting the phosphors such that the phosphors absorbing 313-nm ultraviolet radiation comprise 50% or more of the total weight proportion.

### 2.5.2 Thickness of a Phosphor Layer

As mentioned in the present embodiment, a thickness of the phosphor layer 132 (see FIG. 9) is preferably from 14 μm to 25 μm (more preferably, from 16 μm to 22 μm).

The thickness referred to here is an average thickness of the phosphor layer 132 at four arbitrary positions such as 0, 90, 180, and 270 degrees from a center of a cross section of the glass bulb 130 observed using an SEM (scanning electron microscope). Here, if a surface of the phosphor layer 132 at any of the four positions is not flat, a thickness of a thickest portion is measured.

If the thickness of the phosphor layer 132 is less than 14 μm, ultraviolet radiation generated in the glass bulb 130 is more likely to pass through the glass bulb 130 without being converted to visible light, and so a sufficient visible light conversion efficiency cannot be attained. If the thickness of the phosphor layer 132 is more than 25 μm, light is more likely to be blocked by the phosphor layer 132, and so sufficient visible light conversion efficiency cannot be attained.

### 2.5.3 254-nm Ultraviolet Radiation

Although not mentioned in detail in the present embodiment, 254-nm ultraviolet radiation may also degrade constituent elements of the backlight unit. In order to avoid this situation, borosilicate glass which has the property of absorbing 254-nm ultraviolet radiation is used in the glass bulb 130 (see FIG. 9) of the present embodiment.

The above property can be realized by doping borosilicate glass with at least about 0.5% to 1.0% by weight of a total weight composition of a ultraviolet absorber, such as titanium oxide, cerium oxide and zinc oxide.

### 2.5.4 Phosphor Layer Formation Method

In the present embodiment, BAM phosphors are used as the blue phosphors. These BAM phosphors are generally known to readily degrade fin a sintering step.

In view of this, a phosphor layer formation method that can suppress the degradation of the BAM phosphors in a sintering step is described below.

In general, as described in the embodiment 1, a phosphor layer is formed through the following four steps: (A) adjusting a phosphor layer suspension; (B) applying the phosphor layer suspension to a glass bulb; (C) drying; and (D) sintering (baking).

The inventors of the present invention have learned that the degradation of the BAM phosphors in the sintering step occurs for the following reason. When the sintering is performed at a temperature of 300° C. to 500° C., moisture adsorbs to the phosphors, as a result of which the phosphors degrade.

Here, the moisture adhering to the phosphors can be removed to a certain extent by reheating at about 200° C. to 300° C. However, once the temperature has dropped to a room temperature or the like after the reheating, moisture may adsorb to the phosphors again. Hence this method cannot produce a sufficient effect.

The inventors of the present invention have found out that this problem can be solved by adding a carboxylate metal salt to the phosphor layer suspension so that the carboxylate metal salt adheres to the phosphors in the adjustment step (A), and causing the carboxylate metal salt, whose decomposition temperature is in a range of 300° C. to 600° C., to react with the moisture to thereby form a metal oxide in the baking step (D).

It is preferable to use yttrium caprylate, yttrium 2-ethylhexanoate, or yttrium octylate as the carboxylate metal salt.

For example, when yttrium caprylate is used, a reaction formula showing a transition of reaction of yttrium caprylate in the above baking step is:

Y(C₇H₁₅COO)₃+H₂O→Y—(OH)₃+3C₇H₁₅COOH→Y₂O₃+H₂O+CO₂

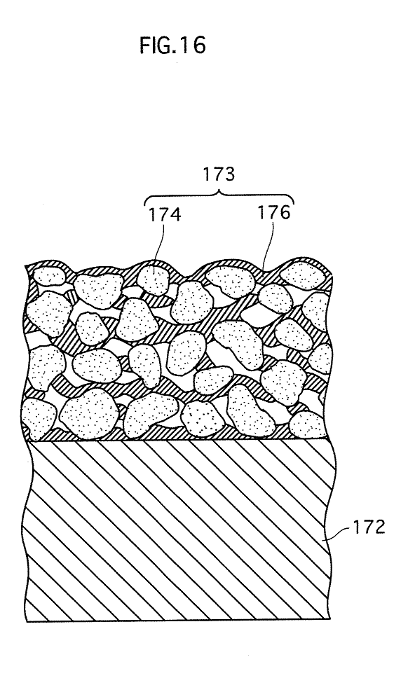

In the sintering step, yttrium caprylate absorbs moisture and thereby forms yttrium oxide, in a temperature range where moisture adsorption to the phosphors occurs. In this way, moisture adsorption to the phosphors in the baking step can be avoided. Yttrium caprylate also reacts with a part of a surface of the phosphors to which moisture tends to adhere, thereby forming an yttrium oxide coating on this part (this coating will be described later with reference to FIG. 16).

As a result, it is possible to significantly reduce the reattachment of moisture to the surface of the phosphors (e.g. moisture adsorption hardly occurs even when the phosphors have been left at room temperature after sintering).

Next is a description of an example of measuring a moisture residue on the phosphor layer when yttrium caprylate is used.

FIG. 15 is a graph showing changes in an amount of OH group (moisture residue) with time in the sintering step. Yttrium caprylate is indicated by a solid line, whereas Yttrium alkoxide is indicated by a broken line. The moisture residue was evaluated based on absorption of light in an OH group absorption band (4300 l/cm), using an FT-IR spectrometer. Each compound was dissolved by butyl acetate, spin-coated on a silicon wafer so as to have a thickness of 0.1 μm, and dried at 100° C. for 30 minutes. After this, changes in moisture residue were observed at 550° C. which is a temperature used in the sintering step.

As shown in FIG. 15, when using yttrium caprylate, moisture was removed in a very short time of a few minutes. This demonstrates that the phosphor layer formation method of embodiment 1 can be effectively used in a phosphor baking step in volume production of lamps.

In contrast, when using yttrium alkoxide, on the other hand, moisture was not removed much. This can be attributed to the fact that yttrium (Y), which is a metal atom, is attacked by the OH group during a hydrolysis reaction.

In comparison, when yttrium caprylate is used, an organic functional group which is combined with yttrium (Y) effectively acts as a steric hindrance to the OH group, thereby suppressing the reaction between yttrium and the OH group.

According to the phosphor layer formation method described above, a lamp that contains a greater amount of BAM phosphors, which are conventionally known to suffer a significant decrease in luminance maintenance rate due to Hg adsorption or the like, can exhibit a long life and a high luminance maintenance rate.

The inventors of the present invention have confirmed that the luminance maintenance rate can be improved by 5% to 10% at 3000 hours.

Also, a color shift (an amount of change in chromaticity x and y) at 3000 hours can be reduced to ½. Thus, a decrease in color reproducibility can be prevented even after extended use.

It should be noted here that the above phosphor layer formation method can be applied not only to BAM phosphors but also to other types of phosphors, and can produce similar effects.

Next is a description of a condition of the phosphor layer obtained after the baking step according to the above phosphor layer formation method.

FIG. 16 shows a cross section of the phosphor layer that was formed.

A phosphor layer 173 on an inner side of a glass bulb 172 is composed of phosphor particles 174 and yttrium oxide coatings (protective films) 176 that span between and cover surfaces of the phosphor particles 174.

The yttrium oxide coatings 176 cover a surface of the phosphor layer 173 and the surfaces of the phosphor particles 174, and span between the phosphor particles 174.

These yttrium oxide coatings 176 have an effect of isolating the mercury, which is enclosed in the lamp, from the phosphor particles 174 and the glass bulb 172.

This makes it possible to prevent the degradation of the phosphor particles 174 caused by a chemical reaction with mercury, and the consumption of the mercury in the discharge space caused by adsorption to the glass bulb 172.

The present invention may be any combinations of the above-described embodiments and modifications.

### INDUSTRIAL APPLICABILITY

The fluorescent lamp manufacturing method pertaining to the present invention is useful because it can provide a fluorescent lamp which prevents degradation of phosphors while securing necessary adherability of a phosphor layer.

1. A manufacturing method for a phosphor suspension to be applied to an inner surface of a glass bulb of a fluorescent lamp, the manufacturing method comprising the steps of:
kneading a mixture of a phosphor powder and a solvent that includes a thickening agent, while keeping a thick consistency thereof; and
adding a metal compound as a coating agent and a solvent that includes a thickening agent and a binding agent to the kneaded mixture, and agitating the mixture.

2. The manufacturing method of claim 1, wherein
the metal compound is an yttrium compound.

3. The manufacturing method of claim 1, wherein
a wall thickness of the glass bulb is 0.5 mm or less.

4. A fluorescent lamp comprising a glass bulb, and a phosphor layer formed on an inner surface of the glass bulb, wherein
the phosphor layer includes a plurality of phosphor particles each coated with a metal oxide, and
the number of phosphor particles contacting the inner surface of the glass bulb, counted along a circumference of a cross section of the glass bulb, is in a range of 0.150 μm to 0.190 μm inclusive.

5. The manufacturing method of claim 4, wherein
a wall thickness of the glass bulb is 0.5 mm or less.

6. A backlight unit comprising the fluorescent lamp of claim 4 as a light source.

7. A liquid crystal display apparatus, comprising a liquid crystal display panel and the backlight unit of claim 6.

8. The fluorescent lamp of claim 4, wherein
the phosphor layer includes three types of phosphor particles, the three types of phosphor particles being red phosphor particles, green phosphor particles and blue phosphor particles that are excited by ultraviolet radiation to emit red light, green light and blue light respectively, and
at least two types of phosphor particles from among the three types of phosphor particles have a property of absorbing ultraviolet radiation with a wavelength of 313 nm.

9. The fluorescent lamp of claim 8, wherein
one of the at least two types of phosphor particles that absorb ultraviolet radiation with a wavelength of 313 nm is the blue phosphor particles, and
the blue phosphor particles are Eu-activated barium magnesium aluminate phosphor particles.

10. The fluorescent lamp of claim 8, wherein
one of the at least two types of phosphor particles that absorb ultraviolet radiation with a wavelength of 313 nm is the green phosphor particles, and
the green phosphor particles are Eu and Mn activated barium magnesium aluminate phosphor particles.

11. The fluorescent lamp of claim 8, wherein
the at least two types of phosphor particles compose 50% or more by weight of a total weight composition of the three types of phosphor particles.

12. The fluorescent lamp of claim 8, wherein
a thickness of the phosphor layer is in a range of 14 μm to 25 μm inclusive.

13. The fluorescent lamp of claim 8, wherein
the glass bulb is borosilicate glass which has a property of absorbing ultraviolet radiation with a wavelength of 254 nm.

14. The fluorescent lamp of claim 8, wherein
yttrium oxide protective films have been formed between the phosphor particles and on surfaces thereof.

15. A backlight unit comprising the fluorescent lamp of claim 8.

16. A liquid crystal display apparatus, comprising a liquid crystal display panel and the backlight unit of claim 15.

17. A direct-type backlight unit, comprising:
a plurality of the fluorescent lamps of claim 8; and
a diffusion plate disposed on a light extracting side, and being a polycarbonate resin.
